(19) United States
(12) Patent Application Publication
(10) Pub. No.: US 2002/0176405 A1
(43) Pub. Date: Nov. 28, 2002

(54) Cost control in a SIP based network

(76) Inventor: Timo Aijala, Tampere (FI)

Correspondence Address: Spencer C. Patterson, Esq., Jenkens and Gilchrist, P.C., 3200 Fountain Place, 1445 Ross Ave., Dallas, TX, 75202, US

(21) Appl. No.: 10/132,872

(22) Filed: Apr. 25, 2002

(30) Foreign Application Priority Data
Apr. 28, 2001 (GB) GB 0110496.7

(51) Int. Cl. H04L 12/66

(52) U.S. Cl. 370/352; 379/88.17

(57) ABSTRACT

A method of controlling costs associated with a Voice Over IP connection by including in a call connection set-up message sent over an IP network a maximum charge parameter and, when the connection is required to break out of the IP network into a telecommunication network, comparing the maximum charge parameter contained in the set-up message with a charge parameter associated with the break out part of the connection, and making a decision on completing the break out part of the connection based on the result of the comparison.

### FIELD OF THE INVENTION

The present invention relates to cost control in a SIP based network, and in particular to a method and apparatus for controlling costs associated with the break out of a call from an IP network into a telecommunications network.

### BACKGROUND TO THE INVENTION

A protocol known as Session Initiation Protocol (SIP) has been specified by the Internet Engineering Task Force (IETF) for creating, modifying, and terminating voice calls carried over an IP network—such calls are often referred to as Voice Over IP (VOIP) calls. Examples of IP networks where SIP might be used are the Internet and local area networks (LANs) using IP.

According to the SIP protocol, user terminals are identified by SIP addresses. A SIP address may have the form john.smith@home, where the prefix portion or user part (i.e. john.smith) of the address is the SIP username of the called party and the suffix portion (i.e. home) identifies the host which could be, for example, the home SIP server to which the called party is attached. Alternatively, the SIP address may have some other form, e.g. it may include a standard telephone number as the user part of the address. A calling party wishing to call a called party generates a SIP INVITE message containing the SIP address of the called party. The SIP INVITE message is typically sent to a SIP server (the calling party knows the IP address of this SIP server). The SIP server identifies the called party from the SIP address, and determines his current location (IP address). The SIP server forwards the SIP INVITE message to that location (possibly via one or more intermediate servers). Upon receiving the SIP INVITE message, the called party is alerted to the call, and the connection can be established. In certain circumstances, the SIP server to which the SIP INVITE message is initially sent may return to the calling party the location of the called party. The calling party may then forward the SIP INVITE message directly to the called party.

It is very desirable to allow voice calls to extend across boundaries between IP networks and more conventional telecommunication networks, e.g. public switched telephone networks (PSTNs) and public land mobile networks (PLMNs). This is facilitated by the use of media gateways and media gateway controllers, with the former handling translations at the bearer level and the later handling translations at the call control level (and controlling the media gateway accordingly, e.g. to establish suitable bearers for voice data).

When a call initiated by a terminal coupled to an IP network (e.g. the Internet) breaks out of the IP network into a PSTN or PLMN, for example to reach a called party who is a subscriber of the PSTN/PLMN, the operator of the PSTN/PLMN may levy a charge for the break out part of the call (in addition to any charge levied for the IP part of the call). This charge will typically be levied against the calling party (perhaps via the calling party's Internet Service Provider (ISP)). Where the calling party's terminal is coupled to the IP network via an access network, e.g. a PSTN, the charge may be levied via the operator of the access network.

### SUMMARY OF THE INVENTION

Users of IP networks such as the Internet are not used to paying connection fees over and above basic network access charges (e.g. a user may pay a fixed monthly fee for Internet access). As such, fees arising from the break-out of a call may be unexpected. The larger the charge, the more unwelcome it will be.

It is an object of the present invention to overcome or at least mitigate the problem identified in the preceding paragraph. In particular, it is an object of the invention to place a limit on the cost of a break out of a call from an IP network, above which the break out may not be authorized.

According to a first aspect of the present invention there is provided a method of controlling costs associated with a Voice Over IP connection, the method comprising including in a call connection set-up message sent over an IP network a maximum charge parameter and, when the connection is required to break out of the IP network into a telecommunication network, comparing the maximum charge parameter contained in the set-up message with a charge parameter associated with the break out part of the connection, and making a decision on completing the break out part of the connection based on the result of the comparison.

The present invention enables callers and/or operators/ISPs to control the costs associated by VOIP connections. This is particularly important as a caller may not know beforehand that a connection which he has initiated will involve a break out from an IP network.

The maximum charge parameter contained in the IP set-up message may be a fixed monetary value or an equivalent fixed number of chargeable units. Alternatively, the maximum charge parameter may be a maximum permitted call tariff, e.g. money or units/minute.

The decision on whether or not to complete the break out part of a connection may be made by a media gateway controller (MGC) interfacing the IP network to the telecommunications network. If the MGC determines that the charge parameter contained in the set-up message is less than (or equal to) the charge parameter associated with the break out, the connection is completed. Otherwise, the connection is not completed. Alternatively, if the MGC determines that the charge parameter contained in the set-up message exceeds the charge parameter associated with the break out, the calling party (or the calling party's ISP or access network operator) may be asked to authorize a higher charge.

Preferably, the VOIP connection is established over the IP network using the Session Initiation Protocol (SIP). The message used by SIP to set-up a connection is the INVITE message. The INVITE message contains the maximum charge parameter. Other protocols may be used however to establish the VOIP connection, e.g. H.323.

According to a second aspect of the present invention there is provided a Media Gateway Controller (MGC) for controlling a Media Gateway (MG). The MGC and the MG, operating respectively at the call control and bearer control levels of a communications system and being coupled between an IP network and a telecommunications network, are configured to receive a VOIP connection set-up message from said IP network; compare a maximum charge parameter contained in the set-up message with a maximum charge parameter associated with a break out of the connection into the telecommunications network; and establish a break out connection based upon the result of the comparison.

### BRIEF DESCRIPTION OF THE DRAWINGS

FIG. 1 illustrates schematically a communications system comprising the Internet and a PSTN; and

FIG. 2 is a flow diagram illustrating a method of establishing a voice call over the system of FIG. 1.

### DETAILED DESCRIPTION OF THE PREFERRED EMBODIMENTS

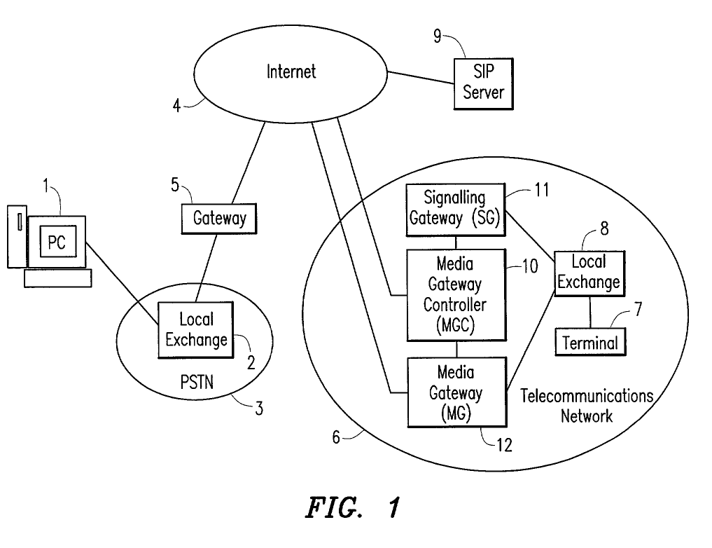

In the communications system illustrated in FIG. 1, a personal computer (PC) 1 is coupled to a local exchange 2 of a PSTN 3. The exchange 2 is in turn coupled to the Internet 4 via a gateway 5. The connection between the PC 1 and the local exchange 2 may be of any suitable type, e.g. it may be via a Plain Old Telephone Service (POTS) line, an Integrated Services Digital Network (ISDN) line, or an Asymmetrical Digital Subscriber Line (ADSL) line. Also coupled to the Internet 4 are a multiplicity of other telecommunication networks, one of which is shown in FIG. 1, identified by the reference numeral 6.

As already described, the PC 1 may initiate a VOIP connection by sending a SIP INVITE message to the SIP server responsible for the called party. Where the called party has an Internet connection, the VOIP connection is set-up from end-to-end using SIP. However, this is not possible where the called party is not connected to the Internet, but rather has only a normal telephone connection. The terminal 7 in FIG. 1 is an example of a terminal having such a normal telephone connection. The terminal 7 is coupled to a local exchange 8 of the network 6.

The terminal 7 has a standard telephone number associated with it (the telephone number serving as the terminal's SIP address). In the event that the PC 1 wishes to establish a connection to the terminal 7, it generates a SIP INVITE message containing the called terminal's SIP address. The INVITE message contains a (new) field, referred to here as the maximum charge field. The PC 1 inserts into this field the maximum tariff (cost/minute) which the user of the PC is willing to pay for a break out of the call from the Internet. It will be appreciated that an INVITE message will always have this field completed, as the PC 1 does not necessarily know from a SIP address whether a connection will require a break out from the Internet or not.

The header of the IP packet within which the SIP INVITE message is encapsulated, has as its destination address the IP address of a SIP server 9 known to the calling party 1 (the calling party's terminal may be pre-programmed with the SIP address of this SIP server). The packet is then sent via the access network 3 and the gateway 5 to the Internet 4. It is relayed through the Internet 4 to the SIP server 9. Based upon the SIP address contained in the SIP INVITE message, the SIP server 9 identifies the current location of the called party. In this case, the location is a Media Gateway Controller (MGC) 10 of the called party's PSTN network 6. Using the IP address of the MGC 10, the SIP INVITE message is forwarded to the MGC 10. It will be appreciated that the called terminal may be associated with a SIP URL (e.g. username@ghost), in which case the SIP server 9 will map the SIP URL to the terminal's telephone number, before forwarding the SIP INVITE message to the MGC 10.

The MGC 10 maintains a record of the call tariffs charged by the access network 6 (alternatively this may be maintained in a charge control server coupled to the MGC). Based for example upon the identity of the called party (i.e. the host part of the destination IP address), the MGC 10 determines the tariff which will be charged by the network operator for the break out part of the call. It compares this determined tariff with the tariff contained in the maximum charge field of the received INVITE message. If the determined tariff is less than or equal to the tariff contained in the maximum charge field, the MGC 10 will generate a call set-up message and pass this to a signalling gateway (SG) 11, which provides an interface between the IP world of the MGC and the Signalling System No. 7 (SS7) world of the network 6.

The SG 11 is a physical entity containing the SG function and it can reside either in its own node or co-reside with MGC 10. The SG 11 terminates the bearer protocol of Circuit Switching Network Signalling information, while the signalling information itself is forwarded on top of a packet-switched bearer, leaving the signalling information unmodified. Typically, the SG 11 terminates the SS7/Message Transfer Part (MTP) session, extracts the ISDN User Part (ISUP) portion, and packetizes it in an IP packet and forwards it to the IP network.

Upon receipt of the call set-up message from the MGC 10, the SG 11 forwards an Initial Address Message over the SS7 network to the local exchange 8. Upon receipt of the set-up message, the local exchange 8 alerts the called party 7. Assuming that the called party 7 answers the call, the local exchange 8 returns an answer message (ANS) to the SG 11, which in turn passes a corresponding message to the MGC 10. The MGC 10 instructs a Media Gateway (MG) 12 to establish a circuit switched connection between the MG 12 and the called party's local exchange 8. The MGC 10 returns an OK message according to the SIP protocol via the Internet 4 to the PC 1, and the PC 1 sends an ACK back to the MGC 10 to complete the SIP negotiation.

On the other hand, if the MGC 10 determines that the tariff identified for the break out exceeds the tariff contained in the call charge field of the INVITE message, the MGC 10 will return a SIP RESPONSE message to the calling party 1. This message includes an appropriate response code (e.g. code 403 “forbidden”) to indicate that the connection set-up has been terminated because the break out tariff exceeds the maximum tariff set by the calling party. No Initial Address Message (IAM) is sent to the called party's local exchange, and no connection over the network 6 is established.

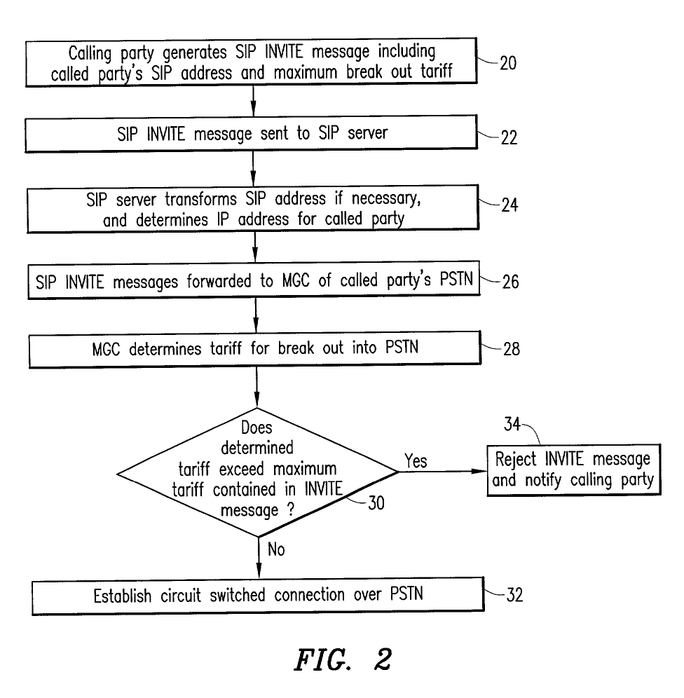

FIG. 2 is a flow diagram illustrating the method of controlling VOIP connection costs. A calling party generates a SIP INVITE message that includes a called party address and the maximum break out tariff (step 20). The SIP INVITE message is transmitted to a SIP server (step 22) that transforms the SIP address contained within the SIP INVITE message into an IP address for the called party (step 24). The SIP INVITE message is then forwarded to the media gateway controller (MGC) of the called party PSTN (step 26). The MGC then determines the tariff for the break out into the called party PSTN (step 28). The determined tariff is then compared to the maximum break out tariff included in the SIP INVITE message (step 30). If the determined tariff is less than the maximum tariff contained in the SIP INVITE message, a circuit switched connection over the PSTN is established (step 32). However, if the determined tariff exceeds the maximum tariff contained in the SIP INVITE message, the SIP INVITE message is rejected and the calling party is notified of the rejection based on the break out tariff exceeding the maximum tariff set by the calling party (step 34).

It will be appreciated by the person of skill in the art that various modifications may be made to the above described embodiments without departing from the scope of the present invention. For example, rather than make an immediate decision on whether or not to allow a break out, the MGC 10 may request permission from the calling party in the event that the expected cost exceeds the specified maximum cost. New SIP messages (or codes) may be defined for this purpose. In another modification, it is the SIP server which makes the maximum charge comparison, and decides either to deny a connection or to seek permission from the calling party (or his operator). This is done for example when the SIP server receives the SIP INVITE message, requiring the SIP server to be able to determine whether a requested connection will require a break out and that the SIP server has a knowledge of break out costs.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method of controlling costs associated with a Voice Over IP connection, the method comprising:
including in a call connection set-up message sent over an IP network a maximum charge parameter;
when the connection is required to break out of the IP network into a telecommunication network, comparing the maximum charge parameter contained in the set-up message with a charge parameter associated with the break out part of the connection; and
making a decision on completing the break out part of the connection based on the result of the comparison.

2. The method according to claim 1, wherein the maximum charge parameter contained in the IP set-up message is a fixed monetary value or an equivalent fixed number of chargeable units.

3. The method according to claim 1, wherein the maximum charge parameter is a maximum permitted call tariff.

4. The method according to claim 1, wherein the decision on whether or not to complete the break out part of the connection is made by a media gateway controller (MGC) interfacing the IP network to the telecommunications network.

5. The method according to claim 1, wherein, if the maximum charge parameter contained in the set-up message exceeds the charge parameter associated with the break out, at least one of a calling party, a calling party's ISP, and an access network operator is asked to authorize a higher charge.

6. The method according to claim 1, wherein the VOIP connection is established over the IP network using a Session Initiation Protocol (SIP) and the call connection set-up message comprises an INVITE message.

7. The method according to claim 6, further comprising carrying out said comparison at a SIP server following receipt at the SIP server of the INVITE message containing the maximum charge parameter.

8. A Media Gateway Controller (MGC) for controlling a Media Gateway (MG), the MGC and the MG operating respectively at the call control and bearer control levels of a communications system and being coupled between an IP network and a telecommunication network, the MGC comprising:
means for receiving a VOIP connection set-up message from said IP network;
means for comparing a maximum charge parameter contained in the set-up message with a charge parameter associated with a break out of the connection into the telecommunication network; and
means for breaking out the connection based upon a result of the comparison.

9. The MGC of claim 8, wherein said VOIP connection set-up message is a session initiation protocol (SIP) INVITE VOIP connection set-up message.

10. The MGC of claim 8, wherein the means for breaking out establishes a circuit switched connection over the telecommunication network when the charge parameter is less than the maximum charge parameter.

11. A method of controlling the cost of a Voice Over Internet Protocol (VOIP) call, said method comprising the steps of:
receiving a call set-up message from an IP network, said call set-up message containing a maximum charge tariff for a part of the call carried on a telecommunication network;
determining a charge tariff associated with the part of the call carried on the telecommunication network;
comparing the charge tariff to the maximum charge tariff; and
establishing a circuit switched connection to the called party if the charge tariff is less than or equal to the maximum charge tariff.

12. The method of claim 11, further comprising the step of:
rejecting the call set-up message if the charge tariff is more than the maximum charge tariff.

13. The method of claim 12, further comprising the step of:
notifying at least one of a calling party, a calling party's ISP, and an access network operator of the rejection of the call set-up message.

14. The method of claim 13, wherein said step of notifying further comprising the step of:
requesting authorization for a higher tariff charge for the call from at least one of a calling party, a calling party's ISP, or an access network operator.

15. The method of claim 11, further comprising, prior to the step of receiving, the steps of:
generating the call set-up message, said call set-up message further containing a called party address; and
forwarding the call set-up message to a media gateway controller of the called party, said media gateway controller performing said step of determining the charge tariff based on the called party address.

16. A system for controlling a cost associated with a Voice Over Internet Protocol (VOIP) connection, said system comprising:
a calling party network configured to send a call connection set-up message over an Internet Protocol (IP) network; and
a media gateway controller configured to receive the call connection set-up message sent over the IP network, determine a charge parameter of a part of a call over a telecommunications network, compare a maximum charge parameter included in the call connection set-up message to the determined charge parameter, and make a decision on completing the call based on the comparison.

17. The system of claim 16, further comprising:
a session initiation protocol (SIP) server for receiving the call connection set-up message from the calling party network and forwarding the call connection set-up message to the media gateway controller.

18. The system of claim 16, wherein the media gateway controller is further configured to establish a circuit switched connection to the called party if the actual charge parameter is less than or equal to the maximum charge parameter.

19. The system of claim 16, wherein the media gateway controller is further configured to reject the call connection set-up message if the charge parameter is more than the maximum charge parameter.
